(19) United States
(12) Patent Application Publication
(10) Pub. No.: US 2020/0389735 A1
(43) Pub. Date: Dec. 10, 2020

(54) BRIDGE-EDGE-TYPE HIGH-RESOLUTION ELECTROMAGNETIC SPEAKER

(71) Applicants: Soojin YU, Pocheon-si, Gyeonggi-do (KR); Sooho YU, Pocheon-si, Gyeonggi-do (KR)

(72) Inventors: Soojin YU, Pocheon-si, Gyeonggi-do (KR); Sooho YU, Pocheon-si, Gyeonggi-do (KR)

(21) Appl. No.: 16/476,018

(22) PCT Filed: Dec. 28, 2017
(86) PCT No.: PCT/KR2017/015602

§ 371 Date: Sep. 23, 2019

(30) Foreign Application Priority Data
Jan. 3, 2017 (KR) 10-2017-0000535

(51) Int. Cl. H04R 7/04; H01F 7/08; H01F 7/02; H01F 27/28; H04R 7/20; H04R 13/00

(52) U.S. Cl. CPC H04R 7/04; H01F 7/081; H04R 13/00; H01F 27/28; H04R 7/20; H01F 7/02

(57) ABSTRACT

The present invention relates to a bridge-edge-type high-resolution electromagnetic speaker, wherein a coil and a permanent magnet, which are a pair of magnetic circuits provided at upper and lower portions of a vibration module, are stacked vertically. It is possible to manufacture a high-resolution loudspeaker having a wide range of applicability from a small-sized earphone with a plug-in type to a portable TV and an automobile. And a damper of a diaphragm of a vibration module may be formed as a magnetic material damper and the coil is directly contacted without any space between the coils, it is possible to transmits the magnetic energy of the coil to the diaphragm without loss and contribute to the amplitude expansion of the diaphragm. As a result, efficiency is increased and the bass reproduction limit frequency is expanded.

### TECHNICAL FIELD

The present invention relates to a bridge-edge type high-resolution electromagnetic speaker, and more particularly, to a bridge-edge type high-resolution electromagnetic speaker in which a coil and a permanent magnet, which are magnetic circuits at upper and lower portions of a vibration module, are stacked vertically to be free to shrink and enlarge the outer size whereby it is manufactured with a micro-sized earphone, and which is capable of directly transmitting magnetic force between a coil and a diaphragm through a vibration module composed of a flexible ferromagnetic damper, thereby reducing magnetic resistance and increasing acoustic conversion efficiency.

### BACKGROUND OF ART

Generally, an electro-macnetic speaker is similar to a dynamic speaker in that the force by the interaction of an AC magnetic field line generated from a wound coil and a DC magnetic field derived from a permanent nagnet, but it different from the dynamic speaker in which a coil is driven, in that the coil is fixed, and the iron piece provided to the coil end is electromagnetically oscillated to perform electro-acoustic conversion.

Electro-magnetic speakers include balanced armature speakers and plate-type speakers. Among these electro-type speakers, those related to plate-type speakers are disclosed in Korean Patent Registration No. 1596894 (hereinafter referred to as Document 1).

In the electro-magnetic speaker in the above Document 1, a permanent magnet is disposed outside the upper and lower coils, respectively and a diaphragm is disposed between the upper and lower coils, of which the top and bottom edges of the diaphragm are disposed between the permanent magnets with the gap-guide so as to be supported by the upper and lower damper members.

In the electro-magnetic speaker of the above-described Document 1, the diaphragm is directly driven by reacting with the magnetic force of the permanent magnet in the state that the diaphragm is magnetized by the electromagnetic force of the upper and lower coils and the weight cf the coil is excluded, and it is possible to realize a quick response, thereby enabling very detailed and detailed sound reproduction.

In addition, since the diaphragm itself is actively driven and converts a sound, the conversion path distortion rate of the diaphragm can be minimized, which is advantageous for reproducing a clean sound.

However, in the electromagnetic speaker as described in above Document 1, since the magnetic circuit is provided in a horizontally arranged structure in which the permanent magnet is placed on the outer side of the coil, it is very disadvantageous in miniaturization of the outer size of the electromagnetic speaker. Therefore, there has been a problem in that the application in a very small earphone with a plug-in type of about 3˜4 mm is restricted.

In addition, since the outer magnetic field of the upper and lower permanent magnets assembled on the outer sides of the upper and lower coils is used as the driving bias of the diaphragm, the distance between the opposite poles of the permanent magnets is long and the magnetic resistance is increased and whereby the acoustic conversion efficiency is reduced.

In addition, since the permanent magnets are fitted to the outer side of the coil to forn magnetic circuits, and the gap guides are positioned between the permanent magnets of the magnetic circuit, assembly tolerances of the magnetic circuit can not be avoided, and the maintaining of symmetry between upper and lower coils and the uniformity of sound pressure/characteristics may cause difficulty in operation.

In addition, since the diaphragm is supported by separate upper and lower damper rings and the gap guide is assembled on the outer side thereof, many parts assembling processes are needed, and non-uniformity of the gap height and damper-ring dimension may occur. If non-uniformity is generated, there is a disadvantage in the uniformity of characteristics/sound pressure/reproduction frequency and is disadvantageous in that there is a possibility of bass leakage.

In addition, since the diaphragm is a single diaphragm in a plate shape such as a circular or elliptical shape, it is limited to expansion of high and low sound areas, and it can be made into a full band by providing a dome or a cone diaphragm. However, due to the strong elasticity of the amorphous alloy material there has been a problem that the manufacturing cost is increased due to the difficulty in molding and manufacturing.

In particular, the electro-magnetic speakers of Document 1 are mostly in resolution, but show limited performance in expanding bass and ultra-treble areas. Therefore, speakers for high-frequency, mid-frequency and bass are systemized for expansion of frequency reproduction band. As a result, the acoustic conversion efficiency is low, besides the price limit, and thus the broad applicability as a high performance speaker for a common sound field space of portable, TV, and automobile other than the earphone and the hearing aid could not be given. Considering that the audio market itself is grov/ing on the basis of high resolution, it is necessary to realize high efficiency of high resolution broadband and sound conversion by one single speaker in order to secure competitiveness of future sound market.

### DISCLOSURE OF THE INVENTION

### Technical Problem

The present invention has been developed to solve the above problems and disadvantages of the conventional loudspeakers. The first object of the present invention is to provide a high-resolution electromagnetic speaker of a bridge-edge type capable of reducing the size and enlarging the outer size of the outer ear so that the earphone can be manufactured from a small-sized earphone with a plug-in type to a portable, TV, and automobile due to the array structure in which coils and permanent magnets, which are a pair of magnetic circuits, are provided at the upper and lower portions of the vibration nodule.

In addition, a second object of the present invention is to provide a bridge-edge type high-resolution electromagnetic speaker, in which the permanent magnets constituting the magnetic circuit are stacked on the coils and protruded and opposed to each other, so that the distance between the opposite poles of the permanent magnets becomes close to each other at a spacing distance, and the inner magnetic field of the permanent magnets may be used as the driving bias of a diaphragm, whereby the prominent magnetoresistance and increasing the acoustic conversion efficiency compared with the prior art are obtained.

In addition, a third object of the present invention is to provide a bridge-edge type high resolution electromagnetic speaker which is advantageous for broadband reproduction, in which the damper of the diaphragm is made of a magnetic material of soft and resilient flexibility with the coil and the diaphragm in direct contact without a separate space, thereby realizing a very low magnetoresistance and transmitting the magnetic energy of the coil to the diaphragm without loss of magnetic energy of the coil so to contribute to the amplitude expansion of the diaphragm, whereby an acoustic conversion efficiency is increased and the bass reproduction limit frequency is lowered.

In addition, a fourth object of the present invention is to provide a bridge-edge type high-resolution electromagnetic speaker in which a bridge edge having a plurality of bridges is provided outside the diaphragm and the outer side of the bridge edge is supported by the damper, so that the flexibility is increased over the entire circumferential support portion of the diaphragm, and very advantageous wide bass enlargement with the increased amplitude displacement and efficiency increase are obtained.

In addition, a fifth object of the present invention is to provide a bridge-edge type high-resolution electromagnetic speaker which includes a vibration module in which a magnetic damper and a stopper outside the diaphragm are integrated by an insert mold method, so that low-frequency leakage may be eliminated, thereby minimizing the manufacturing process and defects and reducing the cost, and a gap-free contact structure between the coil and the diaphragm.

### Technical Solution

In order to accomplish the above objects, according to an aspect of the present invention, there is provided a electromagnetic speaker including a vibration module having at least a diaphragm; a first and a second magnetic circuits each having a pair of coils and permanent magnets provided on upper and lower sides of the vibration module, wherein a first coil constituting a first magnetic circuit is stacked on the vibration module and a second coil constituting a second magnetic circuit is laminated on a lower portion of the vibration module, wherein a first permanent magnet is stacked on an upper surface of the first coil and a second permanent magnet is stacked on a lower surface of the second coil.

The first and second permanent magnets are protruded inwardly of the first and second coils and are disposed to face each other so as to be able to use the internal magnetic force of the permanent magnets as a driving bias.

The diaphragm of the vibration module is injected by an insert mold method so that upper and lower surfaces of the diaphragm are supported by a single damper, and a stopper is integrally provided on the outer peripheral surface of the damper.

The damper is made of a flexible magnetic material in which ferromagnetic for example, iron, nickel, silicon metal, cobalt, etc., powder or particles are mixed with a soft material such as a polymer or silicon so as to transfer the magnetic energy of the first and second coils without loss.

The diaphragm is provided with a plurality of mold tracks in a uniform shape on the outer periphery which is an edge portion so that the flexibility is further increased over the entire edge portion of the diaphragm, and bridges are provided between the mold tracks.

In addition, the diaphragm may be provided in a perforation type in which one to ten holes are perforated in the central part of the body, and a wing type in which several vane blades are formed by a flower-shaped hole formed radially in the center of the body and the vibration wings may be provided in a composite wing type formed symmetrically with different lengths of the vibration wings.

The diaphragm may be provided with a dome-shaped auxiliary diaphragm covering the vibrating wing and the hole concentric with the diaphragm and coaxially coupled to the diaphragm.

The diaphragm may be embossed on the entire or a part of the body so as to suppress plate-resonance of the diaphragm itself.

In the high-resolution electromagnetic speaker of the present invention, the diaphragm is made of a ferromagnetic material such as iron, nickel, silicon, or an alloy thereof, and the auxiliary diaphragm is made of a nonmagnetic material such as a polymer or a diamagnetism and nonferrous metals such as aluminum, magnesium and copper alloys.

In the high-resolution electromagnetic speaker of the present invention, in order to prevent sound leakage to the outside and prevent damage to the coil wire, a soft material pad is provided between the first coil and the first permanent magnet, and between the second coil and the second permanent magnet.

The stopper of the vibration module is provided with an outer wall extending up and down on the outside of the damper for surrounding the outer surface of the first and second coils and the outer peripheral surface of the first and second permanent magnets so as to prevent external leakage of the magnetic field and increase magnetic energy of the bias operation section. A button shape first yoke close to the diaphragm may be provided between the facing inner surfaces of the first and second permanent magnets opposite to the first yoke so as to increase the bias magnetic flux density.

The stopper of the vibration module is provided with an outer wall extending up and down while surrounding an outer major surface of the first and second coils on the outer side of the damper, and a second yoke of a boater type in proximity to the diaphragm is provided on an upper surface of the first permanent magnet and a lower surface of the second permanent magnet,

### Advantageous Effects

According to the bridge-edge type high-definition electromagnetic speaker of the present invention, the coil and the permanent magnets, which are a pair of magnetic circuits provided on the upper and lower sides of the vibration module, are concentrically arranged and stacked vertically, it is possible to manufacture a high-performance speaker corresponding to a general sound field space such as a portable smart phone, a TV or an automobile from a very small and high performance earphone with a plug-in type.

In addition, according to the present invention, the permanent magnets constituting the magnetic circuit are stacked on the coils and protruded and opposed to each other, so that the distance between the opposite poles of the permanent magnets becomes close to each other at a spacing distance, and the inner magnetic field of the permanent magnets, it can be used as a driving bias, so that the magnetic resistance can be reduced and the acoustic conversion efficiency can be increased.

Further, the damper of the vibration module is provided as a flexible magnetic body so that the roagne tores is tance is low and the direct contact is made between the diaphragm and the coil without a separate space, thereby transmitting the magnetic energy of the coil to the diaphragm without loss, and as a result, acoustic conversion efficiency is increased, and the bass reproduction limit frequency is lowered, which is advantageous for broadband reproduction.

Further, in the present invention, since a bridge edge having a plurality of bridges on the outer periphery of the diaphragm is provided and the outer side of the bridge edge is supported by the damper, the flexibility is increased over the entire region of the outer periphery support portion of the diaphragm, so that there is an advantage in that it is more advantageous in expanding the bass extension and increasing the sound conversion efficiency.

In addition, since the vibration module in which the magnetic damper and the stopper outside the diaphragm are integrated by the insert mold method is provided, the coils and the diaphragm implement a clearly tight contact structure through the magnetic damper and so that there is an advantage in that the uneven reproduction characteristic may be solved and the bad goods may be minimized.

### BRIEF DESCRIPTION OF THE DRAWINGS

FIG. 1 is a cross-sectional view of a high-resolution electromagnetic speaker of a bridge-edge type according to an embodiment of the present invention.

FIG. 2 is a plan view of FIG. 1.

FIG. 3 is a bottom view of FIG. 2.

FIG. 4 is an exploded view of a bridge-edge type high-resolution electromagnetic speaker according to the present invention.

FIG. 5 is a detailed plan view showing a vibrating module in a bridge-edge type high-resolution electromagnetic speaker according to the present invention.

FIG. 6 is a plan view showing a diaphragm of the vibration module of FIG. 5.

FIG. 7 is a cross-sectional view taken along line A-A in FIG. 5.

FIG. 8 is a cross-sectional view taken along the line B-B in FIG. 5.

FIG. 9 is a plan view showing another embodiment of the diaphragm in the electromagnetic speaker of the present invention.

FIG. 10 is a cross-sectional view illustrating a bridge-edge type high-resolution electromagnetic speaker according to another embodiment of the present invention.

FIG. 11 is a plan view showing the diaphragm in the electromagnetic speaker shown in FIG. 10.

FIG. 12 and FIG. 13 are plan views showing the diaphragm for a treble diaphragm according to another embodiments of the present invention, which is applicable to the vibration module of FIG. 10.

FIG. 14 is a cross-sectional view illustrating a bridge-edge type high-resolution electromagnetic speaker according to another embodiment of the present invention.

FIG. 15 is a plan view showing the diaphragm in the electromagnetic speaker shown in FIG. 14.

FIGS. 16 to 19 are sectional views showing still another embodiment of a high-resolution electromagnetic speaker according to the present invention.

FIG. 20 is a graph showing a frequency response characteristic of a high-resolution electromagnetic speaker of a bridge edge type according to the present invention and a frequency response characteristic of a conventional electromagnetic speaker.

### DETAILED DESCRIPTION OF THE PREFERRED EMBODIMENTS

The present invention will hereinafter be described in detail wih reference to exemplary embodiments illustrated in the accompanying drawings. For reference, the size, line thickness, and the like of the components shown in the drawings referred to in describing elements of the present invention may be somewhat exaggerated for ease of understanding. Further, the terms used in the description of the present invention are defined in consideration of the functions of the present invention, and may vary depending on the user, the intention of the operator, customs, and the like. Therefore, the definition of a term should be based on the contents of the entire specification.

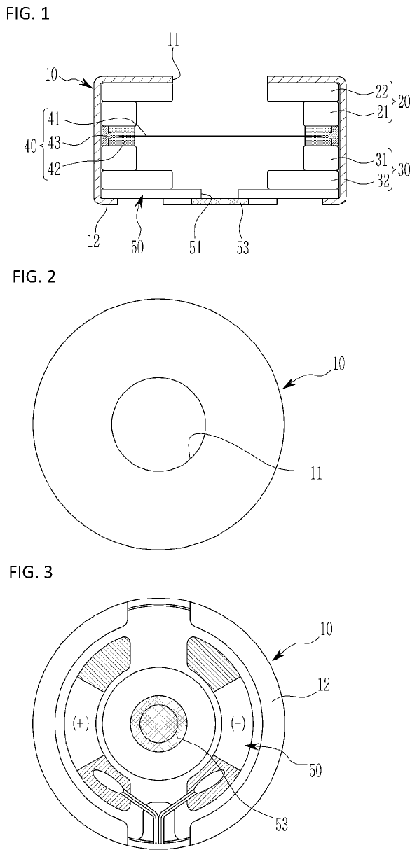

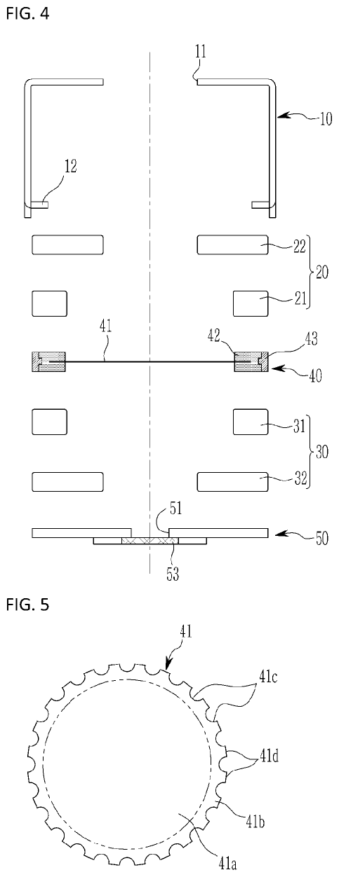

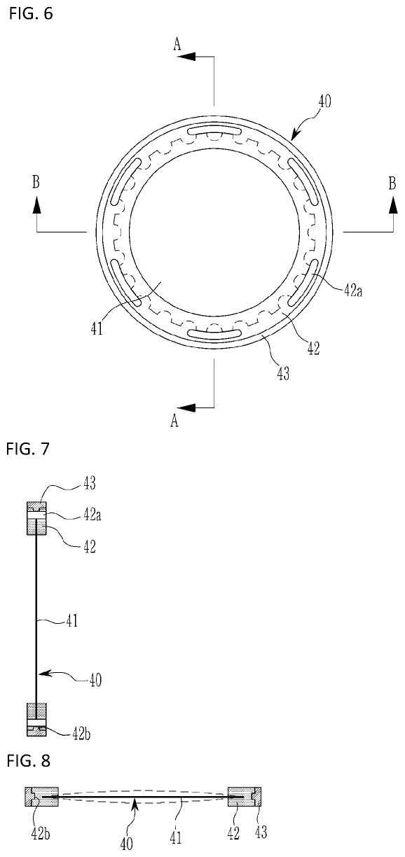

FIGS. 1 to 8 are views illustrating a high-resolution electromagnetic speaker of a kridge-edge type according to an embodiment of the present invention. The high-resolution electromagnetic speaker of this embodiment is an electromagnetic speaker for a full-band, which can be used from bass to treble range.

As shown in the figures, a bridge-edge type high-definition electromagnetic speaker according to an embodiment of the present invention includes a housing 10 having a hollow cap-shaped cross-section, a first magnetic circuit 20 mounted in an upper space inside the housing 10, a seconc magnetic circuit 30 disposed at the opposite to the lower portion of the first magnetic circuit 20, and a vibration module 40 disposed between the first and second magnetic circuits.

The housing 10 must have a space for installing the vibration module 40 and the electrode member 50 as well as the first and second magnetic circuits 20 and 30 therein so that the overall shape of the housing 10 has a hollow cap-shaped cross-section is preferably made of a non-magnetic material such as aluminum. A first acoustic radiation outlet 11 is formed at the center of the upper surface of ihe housing 10 and a bent portion 12 is formed at the lower end of the cap-shaped section in the direction of the center of the housing 10 so as to mount components assembled in the installation space. A plurality of bending portion 12 cut out as much as possible are formed.

The first and second magnetic circuits 20 and 30 comprise a coil and a permanent magnet, respectively. The first magnetic circuit 20 comprises a first coll 21 and a first permanent ruagnet 22 and the second magnetic circuit 30 comprises a second coil 31 and a second permanent magnet 32.

The first coil 21 of the first magnetic circuit 20 is stacked on the upper part of the vibration module 40 and the first permanent magnet 22 is stacked on the upper surface of the first coil 21. The second coil 31 of the first coil 30 is stacked on the lower portion of the vibration module 40 and the second permanent magnet 32 is stacked on the lower surface of the second coil 31. The first and second coils 21 and 31 and the first and second permanent magnets 22 and 32 of the first and second magnetic circuits 20 and 30 are concentric with the vibration module 40, and are stacted on the upper and lower surfact of the vibration module 40 with the structure in which the external diameter is identical, so that outer diameter can be reduced or enlarged. As a result, it can be manufactured as a large high resolution speaker corresponding to a general sound field space of portable, TV, and automobile as well as an ultra snail, high resolution earphone It is preferable that the first and second permanent magnets 22 and 32 are provided so as to protrude inward and to be opposed to the first and second coils 21 and 31. The reason for this is that the opposing inner surfaces of the first and second permanent magnets 22 and 32 protrude toward the inner center without being interrupted by the first and second coils 21 and 31, the internal magnetic energy of the first and second permanent magnets 22 and 32 having high magnetic flux can be used as a driving bias, and therefore is transmitted as it is without magnetic flux loss, and the sound conversion efficiency is increased.

The electrode member 50 is provided in the form of a plate having a second acoustic radiation outlet 51 at the center and disposed on the lower surface of the second permanent magnet 32 of the second magnetic circuit 30 and supplies current to the first and second coils 21 and 31. The second acoustic radiation outlet 51 of the electrode member 50 may be provided with a resistor 53 for controlling the fine sound generated from the low-frequency sound to the high-frequency sound generated by the diaphragm 41. The resistor 53 may be a porous material, for example, a nonwoven fabric, a micro-porous material, or the like.

The first coil 21 and the second coil 31 are connected to each other so that the magnetic field lines of the first and second coils are formed oppositely, whereby the driving force of the diaphragm 41 of the eiectromagnetizea vibration module 40 is obtained from the coils 21 and 31. The diaphragm 41 vibrates up and down in response to the positive and negative periodic electric signals applied to the first and second coils 21 and 31.

The vibrating module 40 is configured such that the peripheral portion of the diaphragm 41 is injected by an insert mold so as to support the top and bottom surfaces of the diaphragm 41 by one damper 42, a stopper 43 is integrally provided at the peripheral portion of the damper 42. The diaphragm 41 constituting the vibration module 40 and the stopper 43 and the damper 42 are injection molded by the insert mold method, thereby minimizing the manufacturing process and defects. It is possible to realize a structure in which the first and second coils 21 and 31 and the diaphragm 41 are in tight contact with each other through the damper 42. The guide hole 42a is formed for setting the diaphragm 41 to the correct position using (not shown) the setting projections of the insert mold by setting projections when the vibration module 40 is insert-injected.

The damper 42 is provided as a magnetic material damper which is formed by mixing the very soft flexible material including polymer or the silicon etc. with the ferromagnetic powder or particles, such as iron, nickel, silicon metal, cobalt, or the like, so that the magnetic energy of the first and second coils 21 and 31 may be transfered without magnetic energy loss. Since the damper 42 of the diaphragm 41 is provided as a very soft magnetic damper, the magnetic resistance is low and the magnetic damper is in direct contact with the first and second coils 21 and 31 without a separate space, it is possible to transmit the magnetic energy of the two coils 21 and 31 without the magnetic energy loss and at the same tine to contribute to the amplitude expansion of the diaphragm 41, as a result, the acoustic conversion efficiency is increased and the bass reproduction limit frequency is lowered and it is advantageous for the reproduction of the entire band.

The fitting irregularities 42b are formed on the contact surface of the damper 42 and stopper 43 so as to prevent the damper 42 and the stopper 43 from being separated from each other. The fitting irregularities 42b are composed of a ring-shaped groove formed on the outer side of the damper 42 and a ring-shaped projection having a shape corresponding to the inner groove of the stopper 43.

Although the fitting irregularities 42b is shown as a quadrangle, any shape may be used as long as it is fittable with each other like a triangle, a circle, or the like. The stopper 43 is made of a rigid material so as to maintain a precise gap between the first and second coils 21 and 31 and at the same time to transmit the magnetic energy of the first and second coils 21 and 31 without magnetic energy loss and may be provided as a ferromagnetic body.

The diaphragm 41 is formed of a ferromagnetic material such as iron, nickel, silicon or the like similar to the stopper 43 and includes a body 41a having a main function of vibration with reference to the imaginary line in FIG. 5, and an edge 41b provided on the outer periphery of the body 41a. The outer periphery of the edge 41b of the diaphragm 41 is provided with a plurality of mold tracks 41c in a uniform shape and a bridge edge 41d is provided between the respective mold tracks 41c.

The diaphragm 41 is provided with the bridge edge 41d having a plurality of bridges on the outer periphery thereof and the bridge edge 41d is supported by the damper 42 of the soft material, so that the flexibility is increased over the entire section of the outer circumference support part of the vibration plate 41 and the top and bottom amplitude displacement grow larger as shown by the dotted line in FIG. 8, which is very advantageous for increasing the bass expansion and the acoustic conversion efficiency.

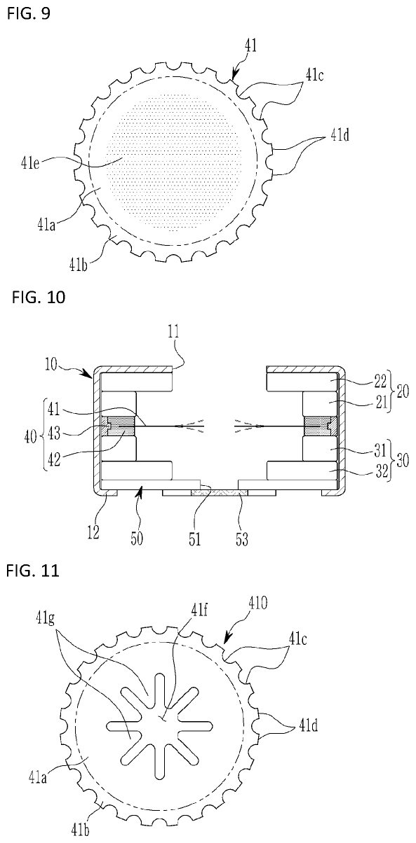

FIG. 9 is a plan view showing another embodiment of the diaphragm in the electromagnetic speaker of the present invention. The diaphragm 41 is the same as the diaphragm of the embodiment except that an embossing 41e is formed on the whole or a certain portion of the body 41a so as to suppress the plate-resonance of the diaphragm itself.

According to the diaphragm of another embodiment as described above, the piate-resonance of the diaphragm itself can be suppressed by the embossing 41e formed on the body 41a, the reduction of the distortion due to suppression of the plate-resonance and reproduction of clear sound are made possible.

FIG. 10 is a cross-sectional view illustrating a bridge-edge type high-resolution electromagnetic speaker according to another embodiment of the present invention, and FIG. 11 is a plan view illustrating a diaphragm applied to FIG. 10. Here, the configuration of the electromagnetic speaker is the same as that of the embodiment of the present invention except that the vibration module 40 is applied to the diaphragm 410 for treble. Accordingly, only the configuration and operation of the diaphragm 410 will be described in detail.

As shown in FIGS. 10 and 11, the diaphragm 410 is provided as a wing type in which several vibrating blades 41g are formed by a flower-shaped hole 41f such as “*” which is formed by incising radially from the center of the body 41a.

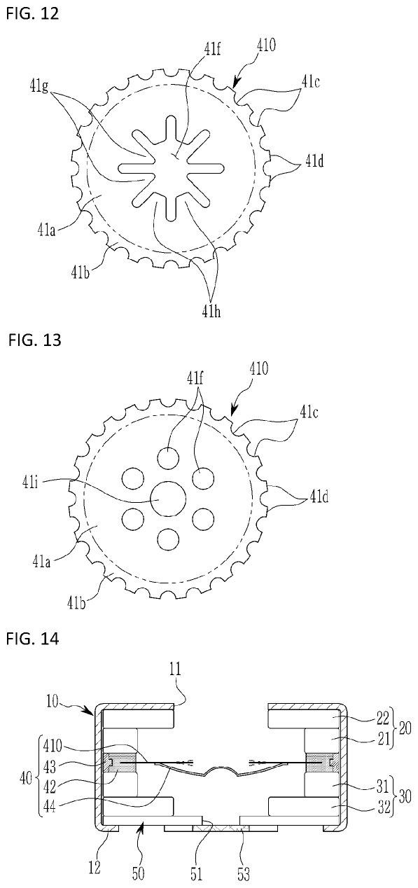

According to the high-resclution electromagnetic speaker of another embodiment as described above, when the bridge edge 41d, which is the outer periphery of the diaphragm 410, is supported by the damper 42, the vibrating blades 41g oscillates freely in a vertical arc motion as shown by a dotted line in FIG. 10. The bass region generated by the vane 41g itself by the shape vignetting hole 41f between the vane blades 41g of the diaphragm 410 is annihilated by itself in a reverse phase, only the high to ultra-high sound generated by the circular motion is released. FIGS. 12 to 13 are plan views showing other embodiments of a treble diaphragm applicable to the vibration module of FIG. 10. The diaphragm 410 shown in FIG. 12 is provided with composite wing type vibration wings 41g and 41h by a shape hole 41f, and the vibration wings 41g and 41h are formed symmetrically with each other, and the length of the vibration wings are differently formed.

According to the treble diaphragm of another embodiment as described above, each of the vibrating blades 41g and 41h can freely oscillate while moving up and down in the state that the outer circumferential bridge ecge 41d of the diaphragm 410 is supported by the damper 42.

The bass regions generated by the vibrating blades 41g and 41h themselves are annihilated in the opposite phase by themselves due to the “*” shape holes 41f between the vibrating blades 41g and 41h of the diaphragm 410, only the middle-high to ultra-high sounds generated by the circular motion of the blades 41g and 41h are emitted.

The diaphragm 410 shown in FIG. 13 has a center hole 41i formed at the central portion of the body 41a and several peripheral holes 41j formed by perforating around the central hole 41i.

According to the diaphragm of this embodiment, the body 41a vibrates while moving up and down with respect to the same circumference of the bridge edge 41d, the bass region generated by the body 41a of the diaphragm 410 by itself is dissipated in a reverse phase by itself with the center and peripheral holes 41h and 41i of the diaphragm 410, so that only the treble or super-high sound generated by the circular movement of the body 41a of the diaphragm 410 is emitted.

The bass extinction region may be changed by changing the area of the holes 41f, 41i, and 41j of the diaphragm 410 for a high tone as described above. When the area of the holes 41f, 41i, and 41j is small, the low-frequency extinction region is low and the low-frequency extinction region is gradually expanded to the high-frequency region as the areas of the holes 41f, 41i, and 41j are larger.

The area of the holes 41f, 41i, and 41j of the diaphragm 410 can be variously designed and nodified because the low-frequency extinction region is varied according to the area of the holes 41f, 41i, and 41j and the high-frequency region is also varied, which is advantageous not only for the enlargement and diversification of the treble range but also for the fine adjustment.

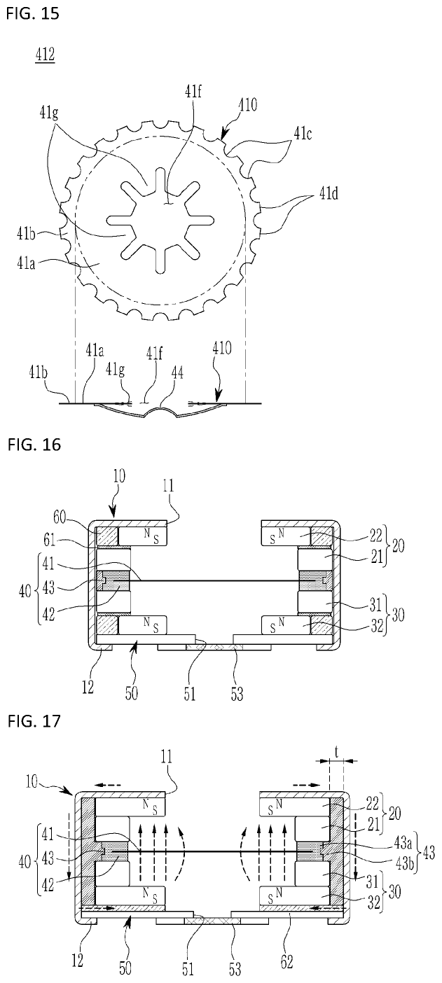

FIG. 14 is a cross-sectional view illustrating a bridge-edge type high-resolution electromagnetic speaker according to another embodiment of the present invention, and FIG. 15 is a plan view and a cross-sectional view illustrating a diaphragm applied to FIG. 14. The configuration of the electromagnetic speaker 412 is the same as that of the electromagnetic speaker of the present invention except that the vibration module 40 is applied to the diaphragm 412 for the wide band. Therefore, only the configuration and operation of the diaphragm 412 will be described in detail.

The broadband diaphragm 412 is provided with a dome type auxiliary diaphragm 44 which covers the vibrating blades 41g and connected to the body 41a of the bottom of the diaphragm 410 for treble of a wing type. The diaphragm 410 is formed of a ferromagnetic material such as iron, nickel, silicon or an alloy thereof. The auxiliary diaphragm 44 is formed of a nonmagnetic material such as a polymer cr a semi-magnetic ferromagnetic material such as aluminum, magnesium or copper alloy.

According to the diaphragm of another embodiment configured as described above, the diaphragm is magnetized into an electric field alternating with the electric signal flowing in the first and second coils 21 and 31, and becomes an active vibrator driven by itself, so that it is possible to realize ultra high resolution of high frequency band from low to ultra high frequency.

More specifically, in the state where the diaphragm 412 for the wide band is supported by the damper 42 of the soft magnetic material on the outer bridge edge 41d, the diaphragm 410 and the auxiliary diaphragm 44 oscillate while moving up and down on the basis of the same circumference as the outer diameter of the bridge edge 41d.

Since the vibrating vane 41g in the body 41a is driven to be arc-like freely as shown by the dotted line in FIG. 14 on the basis of its root portion/the vibrating blade 41g is electromagnetized by the electromagnetic force of the first and second coils 21 and 31 and the second permanent magnets 22, 32, thereby performing self-drive. As a result, it has a very quick response corresponding to an electric signal, so that it is possible to reproduce very detailed and detailed sound.

When the broadband diaphragm 412 is driven at a low frequency, the auxiliary diaphragm 44 together with the diaphragm 410 is coaxially driven in a state of being supported by the damper 42 of the vibration module 40. Therefore, the sound loss due to the reverse phase is prevented, and the bass produced by the auxiliary diaphragm 44 is generated mainly, thereby realizing reproduction of a lower band.

When the wide diaphragm 412 is driven at a high frequency, even if the body 41a of the diaphragm 410 and the auxiliary diaphragm 44 are supported by the damper 42 of the vibration module 40 and do not oscillate in response to high frequencies, but it is driven to be arc-shaped freely from the inside as it is supported by the cantilever on the basis of the roots of the vibrating blades 41g in the body 41a.

When the vibrating blade 41g of the diaphragm 410 is driven to be free arc, the bass generated in the vibrating blade 41g itself, which is circularly moved in the upward and downward directions, disappears under reverse phase and only high sound is generated and released. That is, when the auxiliary diaphragm 44 is driven at a high frequency, the auxiliary diaphragm 44 is in a substantially stationary state, and only the diaphragm 410 physically separated from each ether operates separately, so that it is possible to realize ultimate composite characteristics that are very natural from low to very high.

FIG. 16 is a cross-sectional view showing another embodiment of a bridge-edge type high-resolution electromagnetic speaker according to the present invention, in this embodiment the soft pads 60 are disposed between the first coil 21 and the first permanent magnet 22, as well as between the second coil 31 and the second permanent magnet 32, respectively. The first and second permanent magnets 22 and 32 cut out the outer circumferential portion of the diaphragm 41 which is an unused portion of the permanent magnet except for the driving bias operation section of the diaphragm 41, it is possible to provide a space larger than the inner side and smaller in size than the inner side of the first and second coils 21 and 31, and to replace the reduced space portion as small as the magnet outer ring 61.

According to the electromagnetic speaker of another embodiment as described above, the soft pad 60 is closely arranged between the first coil 21 and the first permanent magnet 22, and between the second coil 31 and the second permanent magnet 32, so that the first and second permanent magnets 22 and 32 can prevent the first and second coils 21 and 31 from being damaged, and at the same time, the low-frequency sound leakage can be prevented.

Since the size of the first and second permanent magnets 22 and 32 is reduced by the size of the outer ring 61 of the magnet, it is possible to reduce the cost of the rare earth magnet, it is possible to concentrate the bias magnetic field of the magnetic field inward.

FIG. 17 is a cross-sectional view showing still another embodiment of a bridge-edge type high resolution electromagnetic speaker according to the present invention, in this embodiment the stopper 43 of the vibration module 40 comprises a spacing protrusion 43a for separating the first and second coils 21 and 31 and an outer wall 43b extending upward and downward to enclose the outer main surfaces of the firs, and second permanent magnets 22 and 32. The thickness t of the outer wall 43b is preferably equal to or greater than the thickness of the first and second permanent magnets 22 and 32. At this time, the stopper 43 is made of a nonmagnetic material, and the housing 10 is made of a magnetic material so as to function as a shield case, and a shield plate 62 made of a magnetic material is provided on the lower surface of the second permanent magnet 32 .

According to the electromagnetic speaker of another embodiment configured as described above, as shown in dotted line in FIG. 17, the other pole of the first and second permanent magnets 22 and 32 is connected to the housing 10 and the shield plate 62, which are shielded cases, so that the external leakage of the magnetic field may be prevented and the magnetic conversion efficiency of the bias operation section may be increased as well as the acoustic conversion efficiency is increased.

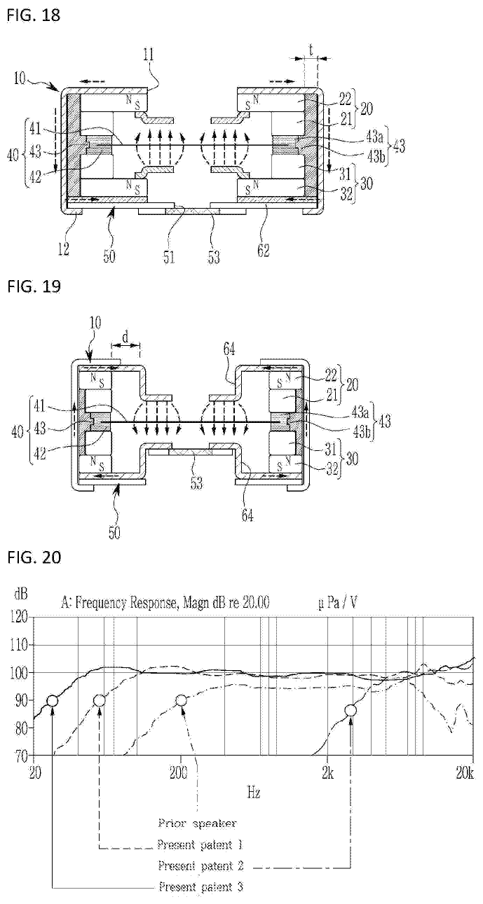

FIG. 18 is a cross-sectional view showing another embodiment of a bridge-edge type high-resolution electromagnetic speaker according to the present invention, in this embodiment, a button-shaped first yoke 63 is further provided on the opposite inner surfaces of the first and second permanent magnets 22 and 32 close to the diaphragm 41. Other configurations are the same as those in FIG. 15. A third acoustic radiation outlet must be provided in the center of the first yoke 63.

According to the electromagnetic speaker of another embodiment configured as described above, since the button-shaped first yoke 63 brings the diaphragm 41 closer to the first and second permanent magnets 22 and 32, the bias magnetic flux density is increased so that it is very advantageous to increase the acoustic conversion efficiency.

FIG. 19 is a cross-sectional view showing another embodiment of a bridge-edge type high-resolution electromagnetic speaker according to the present invention, in this embodiment/the stopper 43 of the vibration module 40 comprises a spacing protrusion 43a for separating the first and second coils 21 and 31 and a second outer wall 43c extending upward and downward to surround the outer main surface of the first and second coils 21 and 31. In this case, the stopper 43 must be formed of a magnetic material, and the housing 10 must be formed of a non-magnetic material.

A second yoke 64 of a boater type is provided on the upper surface of the first permanent magnet 22 and the lower surface of the second permanent magnet 32 so as to be close to the vibration plate 41. The side wall of the second yoke 64 and the first and second permanent magnets 22 and 32 should be spaced from each other and the spacing distance d should be at least the thickness of the first and second permanent magnets 22 and 32. An acoustic radiation outlet may be provided at the center of the second yoke 64 and a resistor 53 may be provided at the acoustic radiation outlet.

According to the electromagnetic speaker of another embodiment configured as described abov, as shown in dotted line in FPG. 19, since the stoppers 43 of the vibration module 40 connect the other poles of the first and second permanent magnets 22 and 32 to each other, it is possible to prevent external leakage of magnetic field, to increase the magnetic conversion efficiency of the bias operation section as well as increase the acoustic conversion efficiency. In addition, since the second yoke 64 in the shape of a butter makes the diaphragm 41 closer to the first and second permanent magnets 22 and 32, the bias magnetic flux density can be increased, whereby it becomes very advantageous to increase the acoustic conversion efficiency.

FIG. 20 is a graph showing a frequency response characteristic of a high-resolution electromagnetic speaker according to the present invention and a frequency response characteristic of a conventional electromagnetic speaker.

The conventional electromagnetic speaker has a characteristic of about 200 Hz to 10 kHz band as shown in the graph of a conventional speaker.

As shown in the graph of the first aspect of the present invention, since the compliance of the bridge edge formed at the end of the diaphragm and the damper is interlocked and driven, it is possible to reproduce a low frequency of 80 Hz band lower than conventional electromagnetic speakers. Furthermore, since magnetoresistance is greatly reduced due to the tight contact structure of the coil and diaphragm through the magnetic damper, very high acoustic conversion efficiency and the characteristic of full-band reproduction in which high frequency limit frequency broadens to 20 kHz band compared to conventional electromagnetic speakers are shown.

As shown in the graph of the second aspect of the present invention, the high-frequency electromagnetic speaker of the present invention has features that eliminate low frequency by itself and reproduce only high frequency without a separate high pass filter and reproduces detail at high speed up to the ultra-high frequency range much higher than 20 KHz without high pass filter due to a very low mass perforated type, a wing type and a composite wing type diaphragm performing circular motion. Also, since the coils and the diaphragm implement a clear contact structure through the magnetic damper, the magnetoresistance is greatly reduced, and the reproducing characteristic is higher than that of the conventional electromagnetic speaker.

As can be seen from the graph of the third aspect of the present invention, the broadband electromagnetic speaker of the present invention provides an advantage of realizing ultra-wideband sound reproduction exceeding the audible range limit frequency of 20 kHz or more from a frequency of 40 Hz or less, in spite of a single speaker. In addition, since the high-frequency limit frequency of the auxiliary diaphragm and the low-frequency limit frequency of the diaphragm fused to one body are naturally connected, the loss and distortion due to the non-coaxial are minimized, thereby reproducing high quality sound with excellent separation, and the characteristic interlocking in the crossover region where the bass portion and the treble portion cross each other while the frequency of each region clearly separated acoustically is reproduced.

While the present invention has been particularly shown and described with reference to exeiplary embodiments thereof, it is to be understood that the invention is not limited to the disclosed exemplary embodiments and the accompanying drawings, and various changes and modifications may be made by those skilled in the art and all of the design change elements are included in the present invention as long as the driving principle and the arrangement of the parts are in conformity with the equivalent concept of the present invention.

### INDUSTRIAL APPLICABILITY

The bridge-edge type hign-resolution electromagnetic speaker according to the present invention can be advantageously used in a speaker field from an earphone-type micro earphone to large-sized speaker for a TV and an automobile.

1. A bridge-edge high-resolution electromagnetic speaker, comprising:
a vibration module with at least a diaphragm;
a pair of first and second magnetic circuits formed by a coil and a permanent magnet on upper and lower portions of the vibration module;
wherein a first coil constituting a first magnetic circuit is stacked on the vibration module and a second coil constituting a second magnetic circuit is stacked on the lower part of the vibration module, and wherein a first permanent magnet is stacked on the upper surface of the first coil, and a second permanent magnet is stacked on the lower surface of the second coil.

2. The bridge-edge high-resolution electromagnetic speaker according to claim 1,
wherein the first and second permanent magnets protrude inwardly of the first and second coils so as to use the internal magnetic force of the permanent magnets as a driving bias, and are arranged to be opposed to each other.

3. The bridge-edge high-resolution electromagnetic speaker according to claim 1,
wherein the vibrating module is constructed such that a peripheral portion of the diaphragm is injected by an insert mold method so as to support the top and bottom surfaces of the diaphragm by one damper and a stopper is integrally provided on the outer surface of the damper.

4. The bridge-edge high-resolution electromagnetic speaker according to claim 3,
wherein the damper may be a magnetic damper in which a soft material such as a polymer or silicon is mixed with a ferromagnetic powder or particles such as iron, nickel, silicon metal, cobalt, etc, so as to transfer the magnetic energy of the first and second coils without loss.

5. The bridge-edge high-resolution electromagnetic speaker according to claim 3,
wherein the diaphragm is provided with a plurality of mold tracks in a uniform shape on the outer periphery which is an edge portion so as to increase the flexibility over the entire edge portion of the diaphragm and each bridge edge is provided between the mold tracks.

6. The bridge-edge high-resolution electromagnetic speaker according to claim 5,
wherein the diaphragm is embossed on the entire or a part of the body so as to suppress plate-resonance of the diaphragm itself.

7. The bridge-edge high-resolution electromagnetic speaker according to claim 5,
wherein the diaphragm is provided with a vane type in which several vanes are formed by a flower-shaped hole such as “*” formed radially in the center of the body.

8. The bridge-edge high-resolution electromagnetic speaker according to claim 5,
wherein the diaphragm is provided with a composite wing type symmetrically formed with different lengths of vibration wings.

9. The bridge-edge high-resolution electromagnetic speaker according to claim 7,
wherein the diaphragm is provided with a dome-shaped auxiliary diaphragm concentric with the diaphragm and covering the hole and the vibration wing so as to be coaxially engaged with the diaphragm.

10. The bridge-edge high-resolution electromagnetic speaker according to claim 5 or 6 claim 5.
wherein the diaphragm is provided with a perforation type in which one to about ten holes are perforated in a central part of the body.

11. The bridge-edge high-resolution electromagnetic speaker according to claim 1,
wherein a soft pad is interposed between the first coil and the first permanent magnet and between the second coil and the second permanent magnet, respectively, for preventing the coil from being damaged, and for tight contact therewith.

12. The bridge-edge high-resolution electromagnetic speaker according to claim 3,
wherein the stopper of the vibration module is provided with an outer wall extending up and down on the outside of the damper for surrounding the outer surface of the first and second coils and the outer peripheral surface of the first and second permanent magnets so as to prevent external leakage of the magnetic field and increase magnetic energy of the bias operation section.

13. The bridge-edge high-resolution electromagnetic speaker according to claim 3,
wherein a button shape first yoke close to the diaphragm is provided between the facing inner surfaces of the first and second permanent magnets opposite to the first yoke so as to increase the bias magnetic flux density.

14. The bridge-edge high-resolution electromagnetic speaker according to claim 3,
wherein the stopper of the vibration module is provided with an outer wall extending up and down while surrounding an outer major surface of the first and second coils on the outer side of the damper, and a second yoke of a boater type in proximity to the diaphragm is provided on an upper surface of the first permanent magnet and a lower surface of the second permanent magnet.

15 A bridge-edge high-resolution electromagnetic speaker, comprising:
a vibration module with at least a diaphragm;
a pair of first and second magnetic circuits formed by a coil and a permanent magnet on upper and lower portions of the vibration module;
wherein the vibrating module is constructed such that a peripheral portion of the diaphragm is injected by an insert mold so that the top and bottom surfaces of the diaphragm are supported by a single damper and a stopper is integrally provided on the outer main surface of the damper.

16. The bridge-edge high-resolution electromagnetic speaker according to claim 15,
wherein the damper may be a magnetic damper in which a soft material such as a polymer or silicon is mixed with a ferromagnetic powder or particles such as iron, nickel, silicon metal, and cobalt so as to transfer the magnetic energy of the first and second coils without loss.

17. The bridge-edge high-resolution electromagnetic speaker according to claim 15,
wherein the diaphragm is provided with a plurality of mold tracks in a uniform shape on the outer periphery which is an edge portion so as to increase the flexibility over the entire edge portion of the diaphragm and each bridge edge is provided between the mold tracks. High resolution electromagnetic speaker.

18. The bridge-edge high-resolution electromagnetic speaker according to claim 15,
wherein the diaphragm is embossed on the entire or a part of the body so as to suppress plate-resonance of the diaphragm itself.

19. The bridge-edge high-resolution electromagnetic speaker according to claim 15,
wherein the diaphragm is provided as a vane type in which several vanes are formed by a flower-shaped hole such as “*” formed radially in the center of the body.

20. The bridge-edge high-resolution electromagnetic speaker according to claim 19,
wherein the diaphragm is provided as a composite wing type symmetrically formed with different lengths of vibration wings.

21. The bridge-edge high-resolution electromagnetic speaker according to claim 15,
wherein the diaphragm is provided with a dome-shaped auxiliary diaphragm concentric with the diaphragm and covering the hole and the vibration wing so as to be coaxially engaged with the diaphragm.

22. The bridge-edge high-resolution electromagnetic speaker according to claim 15,
wherein the diaphragm is provided as a perforation type in which one to about ten holes are perforated in a central portion of the body.

23. The bridge-edge high-resolution electromagnetic speaker according to claim 6,
wherein the diaphragm is provided with a vane type in which several vanes are formed by a flower-shaped hole such as “*” formed radially in the center of the body.

24. The bridge-edge high-resolution electromagnetic speaker according to claim 6,
wherein the diaphragm is provided with a composite wing type symmetrically formed with different lengths of vibration wings.

25. The bridge-edge high-resolution electromagnetic speaker according to claim 6,
wherein the diaphragm is provided with a perforation type in which one to about ten holes are perforated in a central part of the body.

26. The bridge-edge high-resolution electromagnetic speaker according to claim 11,
wherein a button shape first yoke close to the diaphragm is provided between the facing inner surfaces of the first and second permanent magnets opposite to the first yoke so as to increase the bias magnetic flux density.

27. The bridge-edge high-resolution electromagnetic speaker according to claim 17,
wherein the diaphragm is embossed on the entire or a part of the body so as to suppress plate-resonance of the diaphragm itself.

28. The bridge-edge high-resolution electromagnetic speaker according to claim 17,
wherein the diaphragm is provided as a vane type in which several vanes are formed by a flower-shaped hole such as “*” formed radially in the center of the body.

29. The bridge-edge high-resolution electromagnetic speaker according to claim 17,
wherein the diaphragm is provided with a dome-shaped auxiliary diaphragm concentric with the diaphragm and covering the hole and the vibration wing so as to be coaxially engaged with the diaphragm.

30. The bridge-edge high-resolution electromagnetic speaker according to claim 17,
wherein the diaphragm is provided as a perforation type in which one to about ten holes are perforated in a central portion of the body.
